(19) United States
(12) Patent Application Publication
(10) Pub. No.: US 2022/0092688 A1
(43) Pub. Date: Mar. 24, 2022

(54) SYSTEMS AND METHODS FOR FORECASTING AND ADJUSTING STEADY RECURRING TRANSACTIONS THAT ARE SOFT/HARD - COMMITTED WITH COMPUTATION AND USER FEEDBACK

(71) Applicant: JPMORGAN CHASE BANK, N.A., New York, NY (US)

(72) Inventors: Liang ZHOU, New York, NY (US); Mathieu CLICHE, New York, NY (US); Robert CASTELLANO, Brooklyn, NY (US); Ryan KELLERMAN, Hillsborough, NJ (US); Dinesh KASTI, New York, NY (US); Itamar PERLOV, Cresskill, NJ (US); John Andrew ADAMS, New York, NY (US); Samantha CLARK, Sea Cliff, NY (US); James KIM, New York, NY (US)

(21) Appl. No.: 17/484,890

(22) Filed: Sep. 24, 2021

Related U.S. Application Data
(60) Provisional application No. 63/082,737, filed on Sep. 24, 2020.

(51) Int. Cl. G06Q 40/02

(52) U.S. Cl. CPC G06Q 40/02

(57) ABSTRACT

A computer-implemented method for pacing a spend may include: (1) receiving, at a pacing computer program executed by a computer processor, a spend budget for a user for a period, wherein the spend budget represents income transactions for the period minus recurring or expected expense transactions for the period; (2) determining, by the pacing computer program, a pace of spend for the spend budget at a point in time for the period, wherein the pace of spend may be asymmetrical across the period; (3) determining, by the pacing computer program, a current spend for the period at the point of time; and (4) causing, by the pacing computer program, a display of an electronic device to graphically present the pace of spend for the point in time and the current spend for the period at the point in time.

### RELATED APPLICATIONS

This application claims priority to, and the benefit of, U.S. Provisional Patent Application Ser. No. 63/082,737, filed Sep. 24, 2020, the disclosure of which is hereby incorporated, by reference, in its entirety.

### BACKGROUND OF THE INVENTION

### 1. Field of the Invention

Embodiments relate generally to systems and methods for forecasting and adjusting steady recurring transactions that are soft/hard—committed with computation and user feedback.

### 2. Description of the Related Art

The budgeting process often involves the review of financial records for an individual, such as income, expenses, etc. Because this is a manual process, expenses are often missed, which leads to inaccurate budget forecasting.

### SUMMARY OF THE INVENTION

Systems and methods for forecasting and adjusting steady recurring transactions that are soft/hard—committed with computation and user feedback are disclosed. In one embodiment, a computer-implemented method for pacing a spend may include: (1) receiving, at a pacing computer program executed by a computer processor, a spend budget for a user for a period, wherein the spend budget represents income transactions for the period minus recurring or expected expense transactions for the period; (2) determining, by the pacing computer program, a pace of spend for the spend budget at a point in time for the period, wherein the pace of spend may be asymmetrical across the period; (3) determining, by the pacing computer program, a current spend for the period at the point of time; and (4) causing, by the pacing computer program, a display of an electronic device to graphically present the pace of spend for the point in time and the current spend for the period at the point in time.

In one embodiment, the spend budget may be determined by: retrieving a plurality of posted transactions for a prior period of time; identifying, from the plurality of posted transactions, income transactions and expense transactions; and identifying, from the expense transactions, recurring or expected expense transactions.

In one embodiment, the pace of spend at the point in time may be based on historical spend data for the user, a day of a week, a pace of spend for a similarly situated user, etc.

In one embodiment, the pace of spend may be provided as a range.

In one embodiment, the step of determining the current spend for the period at the point of time may include: retrieving, by the pacing computer program, transactions for the period of time, wherein the transactions comprise credit card transactions and/or check transactions; and summing, by the pacing computer program, the transactions.

In one embodiment, the method may further include: determining, by the pacing computer program, that the current spend may be outside the pace of spend; generating, by the pacing computer program, a spending recommendation based on a difference between the current spend and the pace of spend; and causing, by the pacing computer program, the display to display the spending recommendation.

In one embodiment, the method may further include: receiving, by the pacing computer program, a proposed transaction; simulating, by the pacing computer program, an impact on the pace of spend of the proposed transaction; generating, by the pacing computer program, a transaction recommendation based on the impact on the pace of spend of the proposed transaction; and causing, by the pacing computer program, the display to display the transaction recommendation. The transaction recommendation may include an identification of a point of time in the period at which the proposed transaction has a minimal impact on the pace of spend.

According to another embodiment, an electronic device may include a memory storing a pacing computer program and a computer processor. When executed by the computer processor, the pacing computer may program cause the computer processor to: receive a spend budget for a user for a period; determine a pace of spend for the spend budget at a point in time for the period, wherein the pace of spend may be asymmetrical across the period; determine a current spend for the period at the point of time; and cause a display of an electronic device to graphically present the pace of spend for the point in time and the current spend for the period at the point in time.

In one embodiment, the pace of spend at the point in time may be based on historical spend data for the user, a day of a week, a pace of spend for a similarly situated user, etc.

In one embodiment, the pace of spend may be provided as a range.

In one embodiment, the pacing computer program may further cause the computer processor to: retrieve transactions for the period of time, wherein the transactions comprise credit card transactions and/or check transactions; and sum the transactions.

In one embodiment, the pacing computer program may further cause the computer processor to: determine that the current spend may be outside the pace of spend; generate a spending recommendation based on a difference between the current spend and the pace of spend; and cause the display to display the spending recommendation.

In one embodiment, the pacing computer program may further cause the computer processor to: receive a proposed transaction; simulate an impact on the pace of spend of the proposed transaction; generate a transaction recommendation based on the impact on the pace of spend of the proposed transaction; and cause the display to display the transaction recommendation. The transaction recommendation may include an identification of a point of time in the period at which the proposed transaction has a minimal impact on the pace of spend.

In one embodiment, the memory may further include a forecasting computer program, and the forecasting computer program, when executed by the computer processor, may cause the computer processor to: retrieve a plurality of posted transactions for a prior period of time; identify, from the plurality of posted transactions, income transactions and expense transactions; and identify, from the expense transactions, recurring or expected expense transactions.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for forecasting and adjusting steady recurring transactions that are soft/hard—committed with computation and user feedback according to one embodiment;

FIG. 2 depicts a method for forecasting and adjusting steady recurring transactions that are soft/hard—committed with computation and user feedback according to one embodiment;

FIG. 3 depicts a method for pacing the spend of the customer's spend budget according to an embodiment;

FIG. 4 depicts a method for simulating a spend according to an embodiment;

FIG. 5 depicts an exemplary interface according to one embodiment;

FIG. 6 depicts an exemplary graphical representation of a paced spend and a current spend at a first point in time;

FIG. 7 depicts an exemplary graphical representation of a paced spend and a current spend at a second point in time;

FIG. 8 depicts an exemplary graphical representation of a paced spend and a current spend at a third point in time; and

FIG. 9 depicts an exemplary graphical representation of a paced spend and a current spend at a fourth point in time.

### DETAILED DESCRIPTION OF PREFERRED EMBODIMENTS

Embodiments relate generally to systems and methods for forecasting and adjusting steady recurring transactions that are soft/hard—committed with computation and user feedback.

Embodiments may combine automation and co-creation of an individualized budget tailored to any given customer using a forecasting system that balances real time customer feedback with algorithm driven forecasting. For example, when a user builds a budget for the first time, an algorithm will be applied to the user's income and expenses for a period of time. The algorithm may return items that it identifies as income and recurring expenses, and the user may contextually select to remove or add additional income and/or expense transactions based on real posted events. This facilitates the building of a budget based on real data, and adjusting it in real time as events take place to keep the budget accurate.

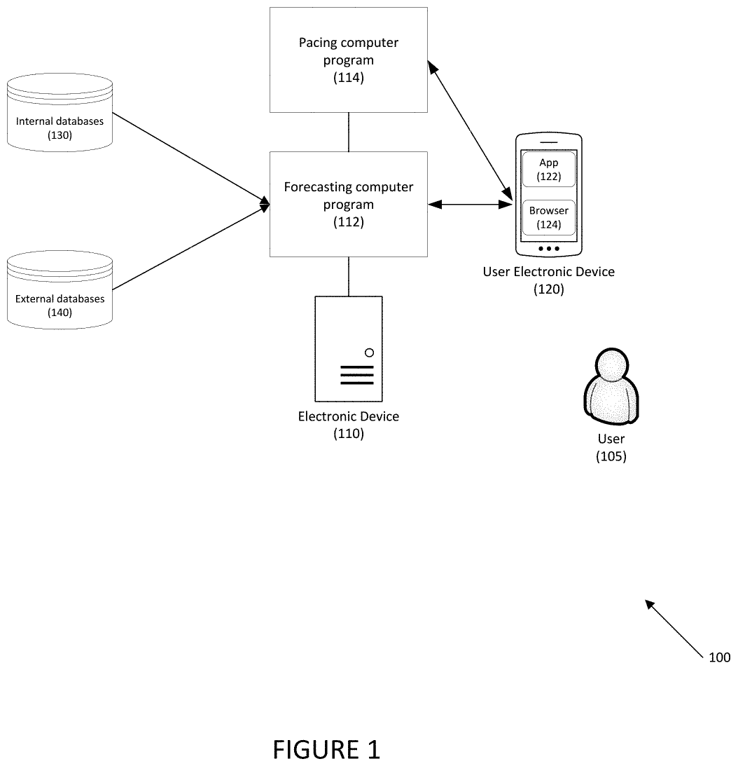

FIG. 1 depicts a system for forecasting and adjusting steady recurring transactions that are soft/hard—committed with computation and user feedback. System 100 may include electronic device 110 that may execute computer programs, including, for example, forecasting computer program 112 and pacing computer program 114. In one embodiment, electronic device 110 may be any suitable computing device, including physical servers, cloud-based servers, combinations thereof, etc.

Forecasting computer program 112 may interface with data sources, such as internal data sources 130 and external data sources 140 to retrieve customer transactions. Examples of data sources include account databases (e.g., demand deposit accounts, savings accounts, credit accounts, etc.), credit card transaction databases, mortgage databases, line of credit databases, aggregator databases, etc. Data from data sources 130 and/or 140 may be retrieved in

Forecasting computer program 112 may apply machine learning and/or algorithms to identify recurring income and expenses from the data received from internal data sources 130 and external data sources 140, and may forecast a “everything else” budget” for the user.

Forecasting computer program 112 may interface with user electronic device 120 which may be a computer (e.g., workstation, desktop, notebook, tablet, etc.), a smart device (e.g., a smart phone), an Internet of Things (IoT) device, etc. User electronic device 120 may execute one or more programs, including application(s) 122, browser 124, etc. User 105 may provide input, feedback, authorization, etc. to forecasting computer program 112 via application(s) 122 and/or browser 124.

Pacing computer program 114 may determine a pace at which the user's spend budget should be spent. In embodiment, pacing computer program 114 may determine the pace based on, for example, historical spending, spending by similarly situated individuals, day of the week (e.g., greater entertainment spending on the weekends), time of year (e.g., holiday spending), personal information (e.g., birthdays, anniversaries, etc.), etc. In one embodiment, pacing computer program may further use spending patterns for similarly situated users (e.g., similar age, income, expenses, type of credit cards, etc.) to determine a pace.

In one embodiment, pacing computer program 114 may use a trained machine learning engine to predict a spending pace. In one embodiment, the machine learning engine may be trained using historical data for the user and/or similarly situated users.

In one embodiment, the pace may be provided as a range (e.g., a dollar range, a percent range, etc.).

In one embodiment, the pace may not be uniform over the period of time, and may vary by periods. For example, the pace may be slower on weekdays than on the weekend, and may change based on actual spending.

In one embodiment, pacing computer program 114 may present the user's current spend and the pace graphically on user electronic device 120.

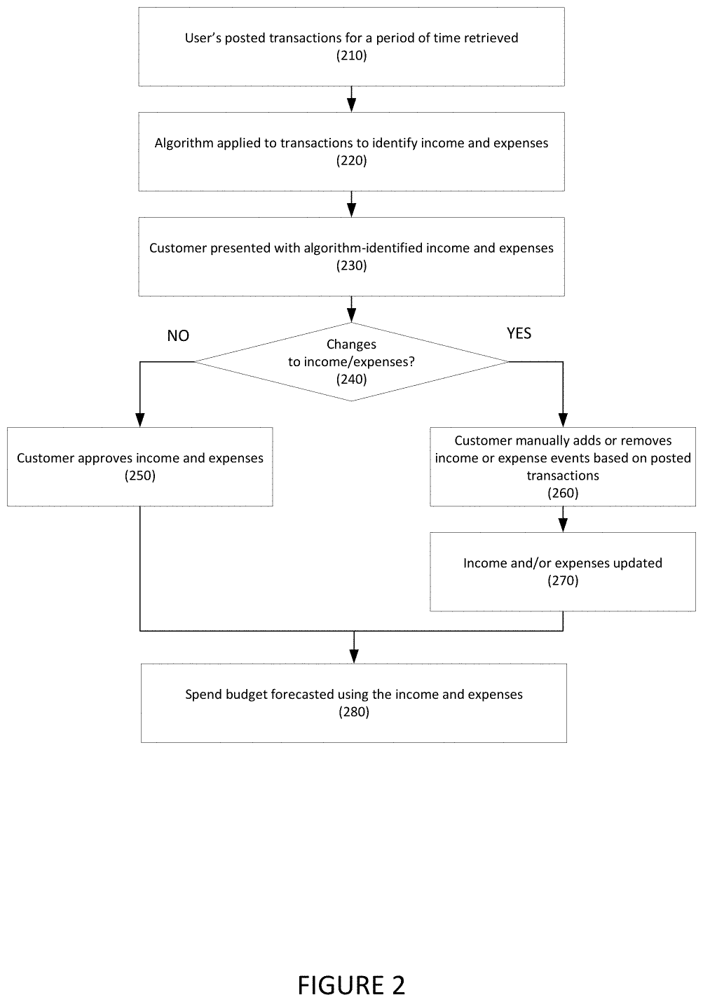

FIG. 2 depicts an embodiment of setting and tracking a budget using algorithmic computation and user feedback according to an embodiment.

In step 210, data from one or more data source may be retrieved. For example, a user's posted transactions for a period of time may be retrieved. Any suitable period of time may be used. In one embodiment, different periods of times may be used for income and expenses, such as four months for income, and six months for expenses.

The posted transactions may be from the customer's demand deposit account (DDA), credit card accounts, savings accounts, mortgage accounts, other loan accounts (e.g., HELOC, auto loan, etc.), or any other account as is necessary and/or desired.

In one embodiment, transactions from within a financial institution and external to the financial institution may be retrieved.

In one embodiment, the transactions may be de-duplicated as is necessary and/or desired. For example, a payment from a DDA to an auto loan account will be counted as a single transaction.

In step 220, one or more algorithms may be applied to the posted transactions to identify income and recurring expenses.

For example, the algorithm may be applied to credit card transactions (i.e., outflow), DDA outflow, and DDA inflow. This may result in three different tables with almost identical schemas.

In one embodiment, the transactions may be grouped by account, transaction code (or MCC for card), merchant name, etc. to find candidate recurring series. The grouped transactions may be further subdivided using their bucketed amounts, where two transactions are in the same bucket if they are within a relative distance of each other (e.g., a maximum relative distance threshold may be in the range of 10-50%).

Candidate recurring series are characterized by a series of amounts, payment dates and lags (in days) between payments. Each of the candidate series then goes through a series of tests to determine if it is indeed recurring. For example:

(a) three separate transactions and three separate dates for the transactions may be required. In addition, in embodiment, the dates may span more than 30 days;

(b) the last transaction date may be such that there are not two missed expected payments (e.g., if a series has a monthly period, it will continue to tag as recurring until it has not been paid in the last two months); and

(c) the total relative variance on the amounts and lags of the series may be below a transaction code (or MCC for card) specific threshold (that is, std(amounts)/avg(amounts)+std(lags)/avg(lags)<=threshold). There may be four possible thresholds: one threshold of 0% to forbid certain types of transactions; one small threshold (e.g., in the range of 5-20%) for low probability of recurring transaction codes; one large threshold (e.g., in the range of 40-70%) for high probability of recurring transaction code; and a default threshold (e.g., in the range of 20-40%).

If the series did not pass (c) because of a large relative lag variance, and there are at least five transactions, a check may be made to see if removing either the smallest lag or the largest lag makes the series pass test (c). This often removes a missed payment of, for example, 60 days lag on a monthly series.

In embodiments, the algorithm may apply time-weighted statistics. For example, when the relative variance on the lags and amounts for candidate series is calculated, the recent lags and amounts count just as much as the old ones. In embodiments, because recent transactions may have a larger impact, time weights may be applied to the relative variance computation.

In step 230, the algorithm-identified income and recurring expenses may be presented to the customer for review. In one embodiment, the algorithm-identified income and recurring expenses may be presented in a user interface, and may be presented with an option for the customer to approve or reject each algorithm-identified income and recurring expense.

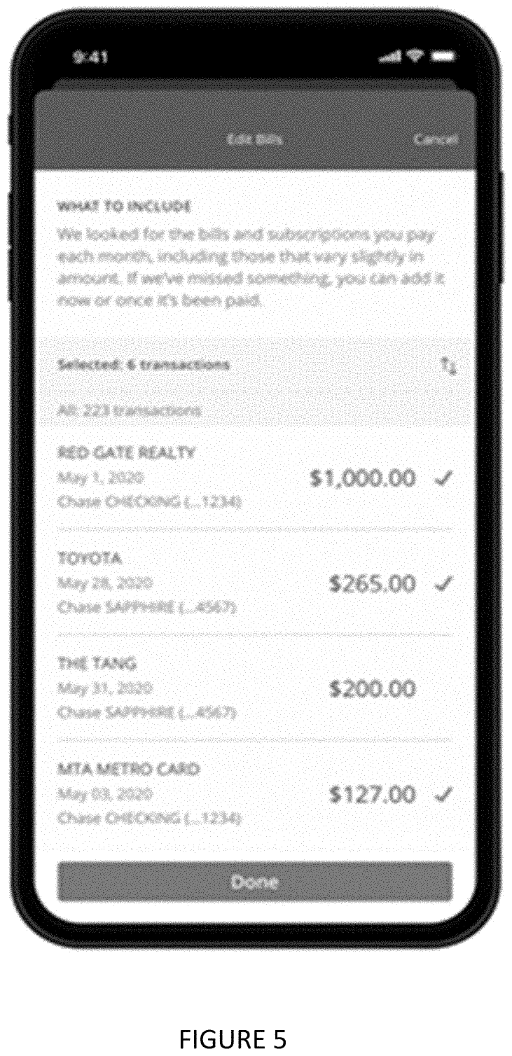

An exemplary interface is provided in FIG. 5.

In step 240, if there are no changes (i.e., the customer approves of all algorithm-identified income and recurring expenses, the customer may approve the algorithm-identified income and recurring expenses in step 250, and in step 280, a budget may be forecasted using the income and recurring expenses.

In step 240, if there are changes (i.e., the customer wants to remove one or more algorithm-identified income or recurring expense, or the customer wishes to add income or a recurring expense based on a posted transaction, in step 260, the customer may remove an algorithm-identified income or recurring expense, or may identify a posted transaction as income or a recurring expense. The customer's selections to add, remove, or re-categorize transactions for the budget is captured as feedback to the system.

In step 270, the customer's income and/or expenses may be updated, and in step 280, the customer's spend budget may be forecasted using the income and recurring expenses. The spend budget may be the result of subtracting recurring and other expected expenses from income.

In embodiments, the forecasting computer program may use lambda architecture and may include real-time services and batch components that leverage the customer's feedback. The real-time services component may be the serving and speed layers of the architecture that enables the user interface to read and update the budget data and layers budgeting revisions on top of the batch processing output. The batch component may handle most of the data/algorithmic processing for the budget, and may also perform the reconciliation of customer overrides against the batch output on a set schedule.

For example, real-time services may operate as follows.

The customer feedback may be converted to metadata that stores the overriding transaction info, such as account, merchant, amount, transaction date, number of transactions in series, feedback action (add, remove, recategorize), etc. The metadata may be used to match, in real-time, against posted transactions to help identify missing/extraneous recurring transactions. The matching will ensure a one-to-one match between transaction and user feedback.

If and when customer intent/cadence is captured as a part of series, the rule may change as follows:

Monthly—1:0 or 1

Bi weekly—1:0 or 1 or 2 (i.e., up to 2)

Weekly—1:0 or 1 or 2 or 3 or 4 (i.e., up to 4)

To optimize the data capture, a similar scoring system may be applied to the recurring algorithm that provides a balance between the distance to the expected payment date and the distance to the expected amount in a way that is also transaction code (or MCC for card) specific. In other words, the first transaction that passes the test (|lag difference|/expected lag+|amount difference|/expected amount)<=threshold, where the threshold is specific to the transaction code/MCC, is captured. The same MCC/transaction code thresholds that are used for the algorithm may be used. For example, this means that if a total relative variance threshold of 50% is used, the allowed distance to the expected amount may vary from 40% (3 days away from the expected date) up to 50% (on the expected date).

This metadata may be used to generate in real-time future behaviors of customer expenses, income, and transfers.

Any subsequent calls to the real-time service for budget data retrieval may trigger the feedback logic to apply its metadata driven datasets to append/remove transactions from the batch-driven output.

The batch component may include the following:

Data-driven tuning: There are several hyper-parameters in the current algorithm (minimum number of transactions, relative variance thresholds, dynamic bucketing size, etc.), which may be tuned using either common sense, human labeled data, etc. As customer feedback is received, it may be used to assemble a large amount of ground truth labels. The hyper-parameters may then be turned to optimize the F1 score on this ground truth data.

Machine learning model: After the data-driven tuning, a machine learning model may be used to classify whether a candidate series is recurring or not. The inputs to this model may include transaction type, merchant, number of transactions, relative variance on amounts, relative variance on lags, etc. This way, the model may effectively learn the rules directly from the data and may outperform the current rule system. The candidate series extraction part of the algorithm may be rule-based, or it may be based on a more complex system where more candidates are produced, but only the highest scoring series within a bucket are recurring.

User customization: The machine learning model outputs a probability that the candidate series is recurring. To allow for user personalization without having to train a different model for a very large number of users, a custom probability cutoff may be used for each customer. In other words, if a customer likes to see all “expected” expenses tagged as recurring (including, for example, fast food restaurant purchases), then the probability for this customer may be low (e.g., 70%). If another customer wants to see only “committed” expenses tagged as recurring, that customer's probability cutoff will be higher, e.g., 95%.

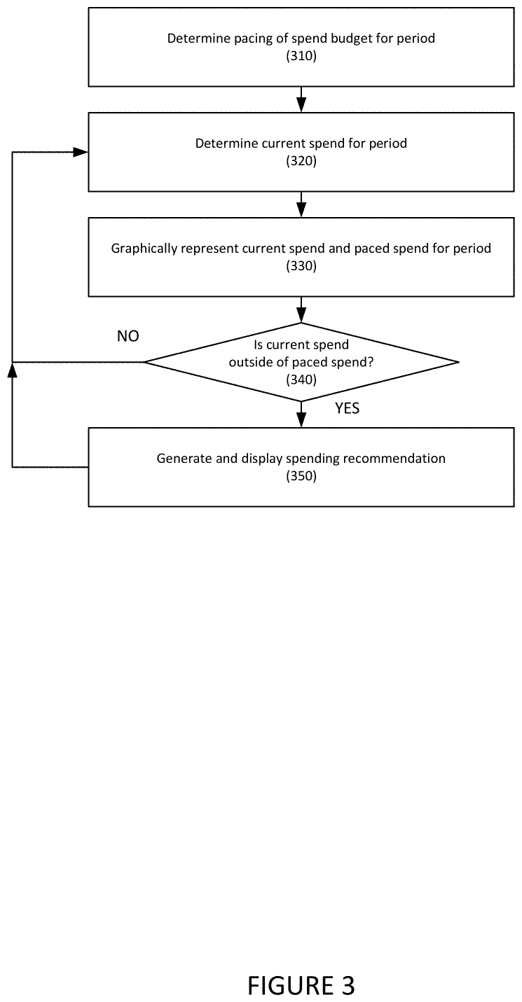

Embodiments may display a paced spend and current spend of the spend budget to the user. Referring to FIG. 3, a method for pacing the spend of the customer's spend budget is disclosed according to an embodiment. FIG. 3 assumes that the a spend budget for the user using, for example, the method of FIG. 2 or any other suitable method (e.g., manual entry).

In step 310, a pacing computer program may determine a pace of spend for the user for a point of time (e.g., a day) in a period (e.g., a month). In one embodiment, the pacing computer program may determine the pace based on, for example, historical spending, spending by similarly situated individuals, day of the week (e.g., greater entertainment spending on the weekends), time of year (e.g., holiday spending), personal information (e.g., birthdays, anniversaries, etc.), etc. In one embodiment, pacing computer program may further use spending patterns for similarly situated users (e.g., similar age, income, expenses, type of credit cards, etc.) to determine a pace.

In one embodiment, the pacing computer program may use a trained machine learning engine to predict a spending pace. In one embodiment, the machine learning engine may be trained using historical data for the user and/or similarly situated users.

In one embodiment, the pace may be provided as a range (e.g., a dollar range, a percent range, etc.).

In embodiments, the pace may be asymmetrical across the period of time. For example, the pace may vary based on day of the week, time of year, personal information, etc.

In step 320, the pacing computer program may determine a current spend for the period. In one embodiment, the pacing computer program may total the user's spending for the period to date. The spending may not include recurring expenses, such as the expenses identified in the process of FIG. 2. Any variance between the expenses identified in FIG. 2 and the actual expense (e.g., a utility bill was higher or lower than identified) may be accounted for.

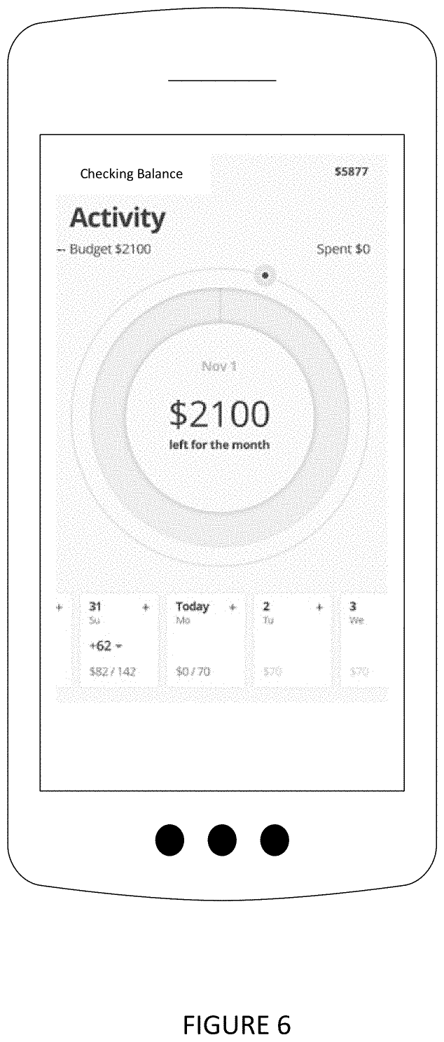

In step 330, the pacing computer program may graphically represent the paced spend and the current spend for the period. For example, FIG. 6 depicts a graphical representation of the total spend (e.g., $2100), the current spend for the period (e.g., $0), and the paced spend (e.g., the marker on the outer circle) at a first point in time. In one embodiment, the paced spend may be represented as a marker, as a range (e.g., a dollar amount, a percentage, etc.).

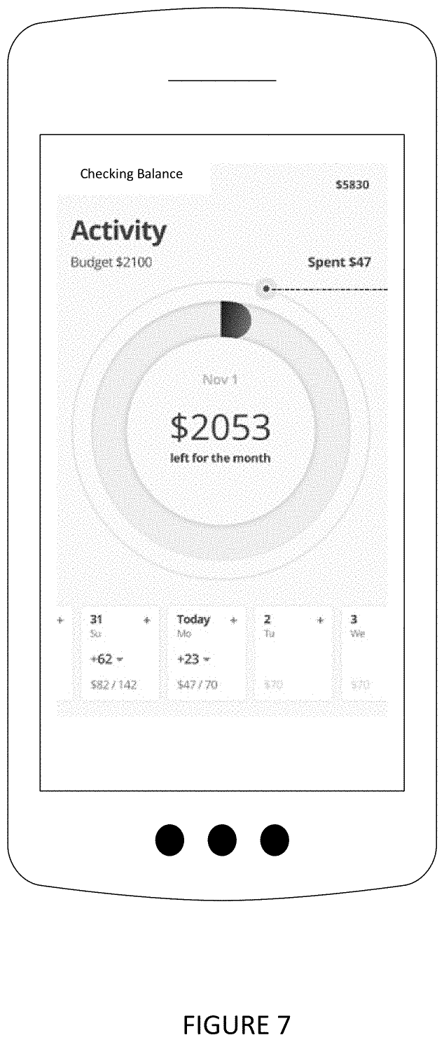

FIG. 7 depicts a graphical representation of a current spend and paced spend at a second point in time after a user spend (e.g., $47) has been identified. The graphical representation may further indicate the amount above or below the paced spend (e.g., $23 below the paced spend of $70) for the date.

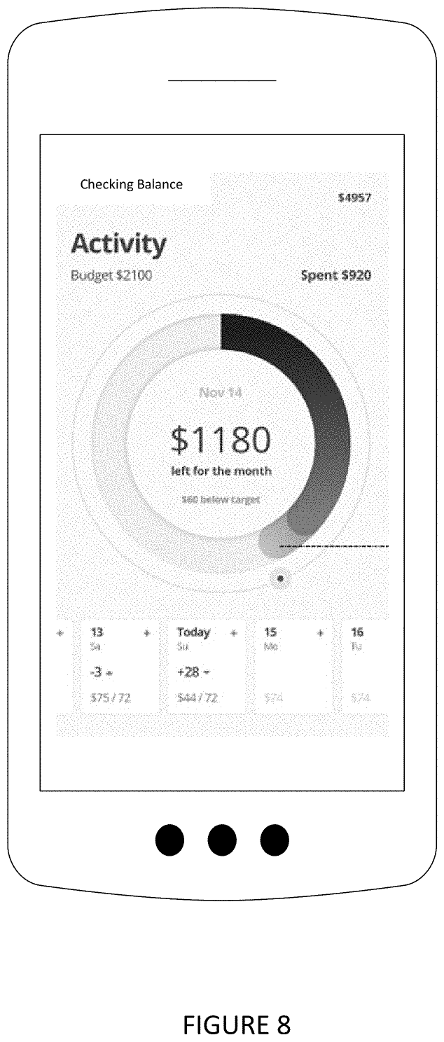

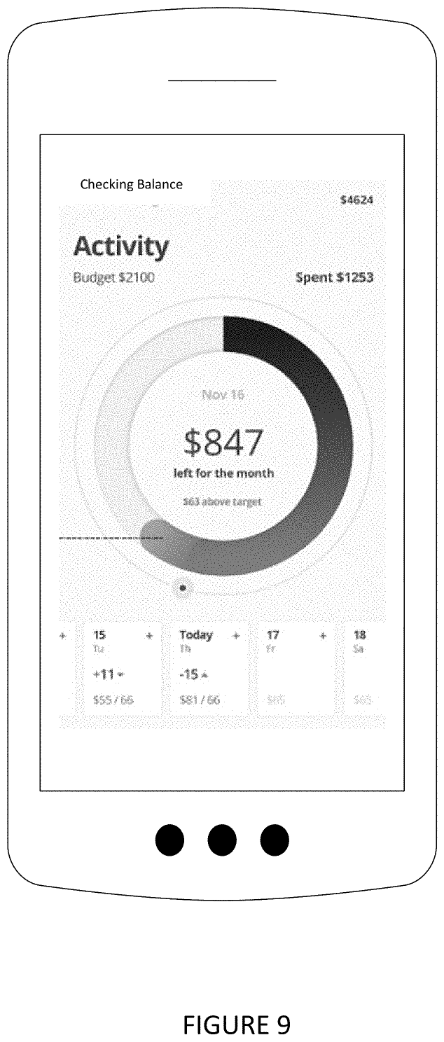

FIG. 8 depicts a graphical representation of a current spend and paced spend at a third point in time. In FIG. 8, the current spend is below the paced spend. And FIG. 9 depicts a graphical representation of a current spend and paced spend at a fourth point in time. In FIG. 9, the current spend is above the paced spend.

It should be noted that the graphical representations of FIGS. 6-9 are exemplary only and other graphical representations and/or manners of presenting the current spend and paced spend may be used as is necessary and/or desired.

Referring again to FIG. 3, in optional step 340, the pacing computer program may determine if the current spend is outside of the paced spend, such as greater than the paced spend. If it is, in step 350, the pacing computer program may generate and display a spending recommendation, such as to decrease spending, to avoid unnecessary spending, etc.

In one embodiment, the pacing computer program may further identify a spending pace for spending categories, such as restaurants, entertainment, transportation, etc., and may provide insights based on spending in that category. If a user has a high spend in a category, the pacing computer program may provide insights or recommendations on how to modify the spending, such as by eating out less, etc.

If the current spend is less than the paced spend, the pacing computer program may recommend saving opportunities, etc. For example, the pacing computer program may automatically transfer funds from checking to a savings account, investment account, etc. on behalf of the user. The automatic transfer may occur if at least a threshold amount of funds remains in the account at the end of the period.

The process may then continue with step 320.

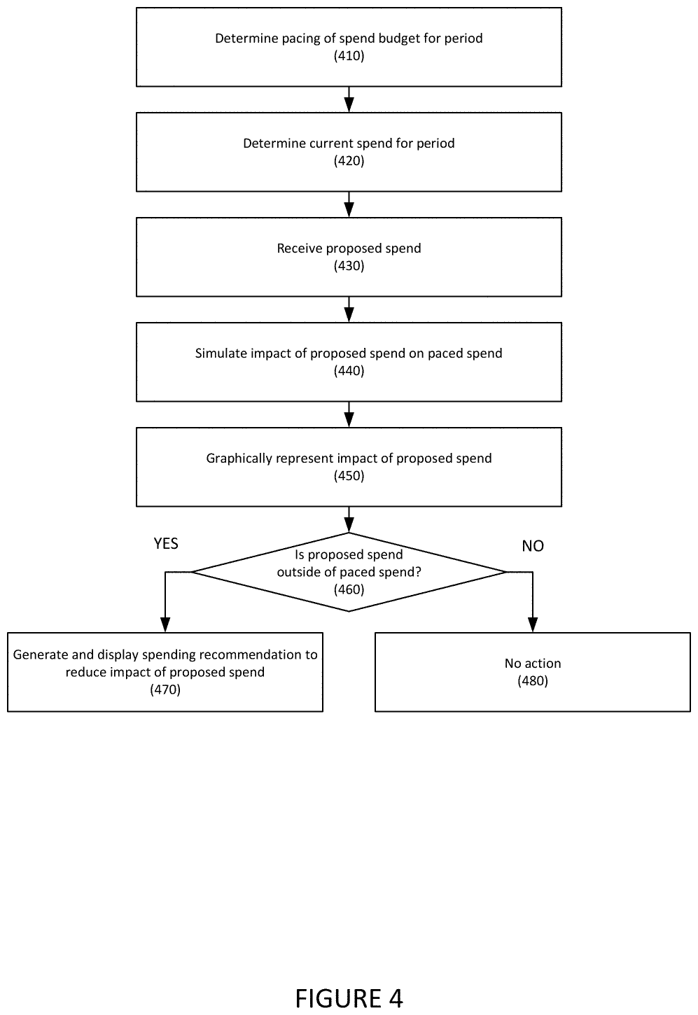

Embodiments may allow the user to simulate a purchase and the impact it may have on the spending pace. Referring to FIG. 4, a method for simulating a spend is provided according to one embodiment.

In step 410, the pacing computer program may determine a pace of spend for the user for a point of time (e.g., a day) in a period (e.g., a month). This may be similar to step 310, above.

In step 420, the pacing computer program may determine a current spend for the period. This may be similar to step 320, above.

In step 430, the pacing computer program may receive a proposed spend from the user. For example, the user may scan an item, enter item details, enter an amount of a spend, etc.

In step 440, the pacing computer program may simulate the impact of proposed spend on the paced spend. For example, the pacing computer program may determine the impact on the paced spend for the period.

In one embodiment, the pacing computer program may simulate the impact of proposed spend at different points of time in the period.

In step 450, the pacing computer program may graphically represent the impact of proposed spend. This may be similar to the manner in which the current spend is presented to the user.

In step 460, if the proposed spend causes the spend to be outside of the paced spend, in step 470, the pacing computer program may generate and display spending recommendation to reduce impact of proposed spend.

In one embodiment, the pacing computer program may recommend a point in time at which the proposed spend minimizes the impact on the paced spend.

In step 480, if the proposed spend causes the spend to be within the paced spend, the pacing computer program may provide a recommendation on the best time to conduct the transaction. In one embodiment, the pacing computer program may identify pricing trends to see if the price for the proposed spend is expected to decrease before the end of the period.

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A computer-implemented method for pacing a spend, comprising:
receiving, at a pacing computer program executed by a computer processor, a spend budget for a user for a period, wherein the spend budget represents income transactions for the period minus recurring or expected expense transactions for the period;
determining, by the pacing computer program, a pace of spend for the spend budget at a point in time for the period, wherein the pace of spend is asymmetrical across the period;
determining, by the pacing computer program, a current spend for the period at the point of time; and
causing, by the pacing computer program, a display of an electronic device to graphically present the pace of spend for the point in time and the current spend for the period at the point in time.

2. The computer-implemented method of claim 1, wherein the spend budget is determined by:
retrieving a plurality of posted transactions for a prior period of time;
identifying, from the plurality of posted transactions, income transactions and expense transactions; and
identifying, from the expense transactions, recurring or expected expense transactions.

3. The computer-implemented method of claim 1, wherein the pace of spend at the point in time is based on historical spend data for the user.

4. The computer-implemented method of claim 1, wherein the pace of spend at the point in time is based on a day of a week.

5. The computer-implemented method of claim 1, wherein the pace of spend at the point in time is based on a pace of spend for a similarly situated user.

6. The computer-implemented method of claim 1, wherein the pace of spend is provided as a range.

7. The computer-implemented method of claim 1, wherein the step of determining the current spend for the period at the point of time comprises:
retrieving, by the pacing computer program, transactions for the period of time, wherein the transactions comprise credit card transactions and/or check transactions; and
summing, by the pacing computer program, the transactions.

8. The computer-implemented method of claim 1, further comprising:
determining, by the pacing computer program, that the current spend is outside the pace of spend;
generating, by the pacing computer program, a spending recommendation based on a difference between the current spend and the pace of spend; and
causing, by the pacing computer program, the display to display the spending recommendation.

9. The computer-implemented method of claim 1, further comprising:
receiving, by the pacing computer program, a proposed transaction;
simulating, by the pacing computer program, an impact on the pace of spend of the proposed transaction;
generating, by the pacing computer program, a transaction recommendation based on the impact on the pace of spend of the proposed transaction; and
causing, by the pacing computer program, the display to display the transaction recommendation.

10. The method of claim 9, wherein the transaction recommendation comprises an identification of a point of time in the period at which the proposed transaction has a minimal impact on the pace of spend.

11. An electronic device, comprising:
a memory storing a pacing computer program; and
a computer processor;
wherein, when executed by the computer processor, the pacing computer program causes the computer processor to:
receive a spend budget for a user for a period;
determine a pace of spend for the spend budget at a point in time for the period, wherein the pace of spend is asymmetrical across the period;
determine a current spend for the period at the point of time; and
cause a display of an electronic device to graphically present the pace of spend for the point in time and the current spend for the period at the point in time.

12. The electronic device of claim 11, wherein the pace of spend at the point in time is based on historical spend data for the user.

13. The electronic device of claim 11, wherein the pace of spend at the point in time is based on a day of a week.

14. The electronic device of claim 11, wherein the pace of spend at the point in time is based on a pace of spend for a similarly situated user.

15. The electronic device of claim 11, wherein the pace of spend is provided as a range.

16. The electronic device of claim 11, wherein the pacing computer program further causes the computer processor to:
retrieve transactions for the period of time, wherein the transactions comprise credit card transactions and/or check transactions; and
sum the transactions.

17. The electronic device of claim 11, wherein the pacing computer program further causes the computer processor to:
determine that the current spend is outside the pace of spend;
generate a spending recommendation based on a difference between the current spend and the pace of spend; and
cause the display to display the spending recommendation.

18. The electronic device of claim 11, wherein the pacing computer program further causes the computer processor to:
receive a proposed transaction;
simulate an impact on the pace of spend of the proposed transaction;
generate a transaction recommendation based on the impact on the pace of spend of the proposed transaction; and
cause the display to display the transaction recommendation.

19. The electronic device of claim 18, wherein the transaction recommendation comprises an identification of a point of time in the period at which the proposed transaction has a minimal impact on the pace of spend.

20. The electronic device of claim 11, wherein the memory further comprises a forecasting computer program, and the forecasting computer program, when executed by the computer processor, causes the computer processor to:
retrieve a plurality of posted transactions for a prior period of time;
identify, from the plurality of posted transactions, income transactions and expense transactions; and
identify, from the expense transactions, recurring or expected expense transactions.
